(19) United States
(12) Patent Application Publication
(10) Pub. No.: US 2023/0419267 A1
(43) Pub. Date: Dec. 28, 2023

(54) ONBOARDING MANAGEMENT ENGINE IN A HUMAN RESOURCES MANAGEMENT SYSTEM

(71) Applicant: Microsoft Technology Licensing, LLC, Redmond, WA (US)

(72) Inventors: Jennifer Lorin JAWORSKI, Kirkland, WA (US); Quentin E. MACKEY, Covington, WA (US); Monique Danae SMITH, Seattle, WA (US); Harsh SRIVASTAVA, Duvall, WA (US); Stephanie TUNG, Berkeley, CA (US); Alisa L. LIDDLE, Oak Park, IL (US); Ronnie Donnell YATES, JR., Sammamish, WA (US); Tina S. BIRADAR, Issaquah, WA (US); Salve R. PASCUAL, Portland, OR (US); Chea THAING, Long Beach, CA (US); Kristen M. SUNNY, Issaquah, WA (US); Vasant Bhaskaran IYER, Vancouver (CA)

(21) Appl. No.: 17/851,502

(22) Filed: Jun. 28, 2022

(51) Int. Cl. G06Q 10/10

(52) U.S. Cl. CPC G06Q 10/1053; G06Q 10/1095

(57) ABSTRACT

Methods, systems, and computer storage media for providing an integrated onboarding platform associated with an onboarding management engine of a human resources management system. The integrated onboarding platform provides integrated onboarding management based on a computing architecture that supports system integration and process integration associated with an onboarding workflow. The onboarding management engine operates based on organizational onboarding logistics and hierarchical integration of onboarding activities of the onboarding workflow having onboarding interfaces. Operationally, a request for onboarding data is received at the onboarding management engine. The onboarding data is associated with an onboarding experience. The onboarding management engine supports generating onboarding plans, the onboarding plans are associated with onboarding configuration data of the integrated onboarding platform comprising onboarding management data from a plurality of data sources and services. The onboarding configuration data associated with the onboarding plan is accessed. Based on the onboarding configuration data, the onboarding data is communicated.

### BACKGROUND

Users rely on human resources management systems to facilitate performing various human resources tasks. Distributed computing systems (e.g., cloud computing platforms) can host a human resources management system—that supports a number of processes—to ensure efficient management of human resources, business processes and data. The human resources management system can support employee onboarding for processes in which new hires are oriented into an organization. For example, a human resources management system can support tasks related to generating and providing hiring forms, processing employee documents, and presenting an onboarding workflow.

Conventionally, human resources management systems are not configured with a computing infrastructure and logic to provide an integrated onboarding platform associated with systems and services of an onboarding workflow. For example, support for onboarding can lack hierarchical integration of resources (e.g., organizational levels, users, content, repositories, reasoning) and onboarding activities of the onboarding workflow. Human resources management systems do not adequately include a computing architecture for system integration and process integration associated with the onboarding workflow and corresponding onboarding interfaces. As such, a more comprehensive human resources management system—with an alternative basis for performing onboarding management operations—can improve computing operations and interfaces in human resources management systems.

### SUMMARY

Various aspects of the technology described herein are generally directed to systems, methods, and computer storage media, for among other things, providing an integrated onboarding platform associated with an onboarding management engine of a human resources management system. The integrated onboarding platform provides integrated onboarding management based on a computing architecture that supports system integration and process integration associated with an onboarding workflow. The onboarding management engine operates based on organizational onboarding logistics and hierarchical integration of onboarding activities of the onboarding workflow having corresponding onboarding interfaces. In this way, the integrated onboarding platform can improve management of an onboarding workflow through integrated onboarding platform operations and interfaces that provide unified onboarding experiences.

Conventionally, a human resources management system can operate independently from other onboarding workflows—including systems and processes—at an organization. Several departments can perform onboarding of an employee in parallel without referencing each other's systems or processes that support their corresponding onboarding workflows. At an organizational level, an employee may be assigned a first set of activities, and at a department level, the employee is assigned a second set of activities. The first set of activities and the second of activities may present time conflicts, they may be duplicated, and further inefficiently use computing resources when a unified approach to onboarding is not supported. A technical solution—to address the technical problems associated with a lack of an adequate unified approach to onboarding employees—can be difficult to develop because of a computing architecture, operations, and interfaces that are implicated and have to be developed in a distributed and efficient manner.

In operation, a request for onboarding data (e.g., wayfinder onboarding data) is received at an onboarding management engine (i.e., human resources management system). The onboarding data is associated with an onboarding experience (e.g., wayfinder onboarding experience). The onboarding management engine supports generating onboarding plans, the onboarding plans are associated with onboarding configuration data (e.g., organization level onboarding configuration data or manager level onboarding configuration data) of an integrated onboarding platform. The integrated onboarding platform includes onboarding management data from a plurality of data sources and services. The onboarding configuration data—associated with the onboarding plan—is accessed and based on the onboarding configuration data, the onboarding data for the onboarding experience is communicated via the human resources management system.

In addition, in some embodiments, a client device causes presentation of an onboarding plan on an onboarding management interface. The client device then receives onboarding data associated with updating the onboarding plan. The onboarding plan is associated with onboarding configuration data of an integrated onboarding platform comprising onboarding management data from a plurality of data sources and services. The client device communicates the onboarding data associated with updating the onboarding plan to cause the integrated onboarding platform to update the onboarding plan—based on updating the onboarding configuration data. The client device causes presentation of the updated onboarding plan on the onboarding management interface.

Moreover, in some embodiments, the onboarding management engine accesses a first set of onboarding configuration data. The first set of onboarding configuration data is associated with an onboarding administrator user. The onboarding management engine supports generating onboarding plans, the onboarding plans are associated with onboarding configuration data of an integrated onboarding platform comprising onboarding management data from a plurality of data sources and services. The onboarding management engine generates an onboarding plan using the first set of onboarding configuration data and assigns the onboarding plan to an onboarding user—the onboarding user is associated with an onboarding manager user. Additionally, the onboarding management engine accesses a second set of onboarding configuration data—the second set of configuration data is associated with the onboarding manager user—and then updates the onboarding plan using the second set of onboarding configuration data. Based on the onboarding data, the onboarding management engine updates the onboarding plan and communicates the updated onboarding plan.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary human resources management system with an onboarding management engine, in which embodiments described herein may be employed;

FIG. 1C is an exemplary schematic associated with a human resources management system with an onboarding management engine, in which embodiments described herein may be employed;

FIGS. 2A and 2B are block diagrams of an exemplary human resources management system with an onboarding management engine, in which embodiments described herein may be employed;

FIGS. 2C-2F are exemplary schematics associated with a human resources management system with an onboarding management engine, in which embodiments described herein may be employed;

FIG. 3 is a flow diagram showing an exemplary method for implementing a human resources management system with an onboarding management engine, in accordance with embodiments described herein;

FIG. 4 is a flow diagram showing an exemplary method for implementing a human resources management system with an onboarding management engine, in accordance with embodiments described herein;

FIG. 5 is a flow diagram showing an exemplary method for implementing a human resources management system with an onboarding management engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION OF THE INVENTION

### Overview

Human resources management systems operate to support onboarding of employees. Different types of human resources management systems provide different levels of support for performing onboarding. For example, a human resources management system can support tasks related to generating and providing hiring forms, processing employee documents, and presenting an onboarding workflow. Nonetheless, conventionally, human resources management systems are not configured with computing infrastructure and logic to provide an integrated onboarding platform associated with systems and services of an onboarding workflow. Different organizational levels and departments provide parallel and isolated implementations of onboarding that lead to several shortcomings in their implementations, including: a lack of visibility and interactivity across the organization, duplication in resources and onboarding activities, and incomprehensive, inefficient, and disconnected functionality in onboarding. As such, a more comprehensive human resources management system—with an alternative basis for performing meeting management operations—can improve computing operations and interfaces in human resources management systems.

Embodiments of the present disclosure are directed to providing an integrated onboarding platform associated with an onboarding management engine of a human resources management system. The integrated onboarding platform provides integrated onboarding management based on a computing architecture that supports system integration and process integration associated with an onboarding workflow. The onboarding management engine operates based on organizational onboarding logistics and hierarchical integration of onboarding activities of the onboarding workflow having corresponding onboarding interfaces.

At a high level, by way of illustration, an onboarding administrator user (e.g., human resources representative, organization-wide representative) accesses a plan builder (e.g., plan builder experience). The plan builder provides access to different data sources, services, and onboarding configuration data for defining features and onboarding activities of an onboarding plan for an onboarding user (e.g., new employee). The onboarding administrator user enters input data (e.g., organization level configuration data) to generate an onboarding plan. The onboarding plan is generated with onboarding plan data that can be presented on an interface. The onboarding administrator assigns (e.g., based on an assignment logic) the onboarding plan to an onboarding manager user (e.g., manager of new employee).

The onboarding manager user accesses the plan builder. The onboarding manager user updates the onboarding plan based on additional input data (e.g., department or manager level configuration data). The onboarding plan can be configured to support organizational onboarding logistics—planning, implementation, and coordination—associated with onboarding workflows. The organizational onboarding logistics can specifically implemented based on a hierarchical computing architecture, constructs, and rules (e.g., prioritize organizational level configuration over department or manager level configuration). The onboarding manager assigns the onboarding plan to an onboarding user (e.g., new employee). The onboarding user accesses the onboarding plan (e.g., via a wayfinder experience) and accesses other features (e.g., dashboard experience, neighborhood experience) of the onboarding plan.

Optionally, the onboarding plan can be updated— (1) before or after the onboarding manager user updates the onboarding plan; or (2) before or after the onboarding plan is assigned to the onboarding user. The onboarding plan can be updated with different types of input data. For example, input data for updates can specifically be received from an onboarding contributor user (e.g., department head; or team member of the new employee). The updates can be to features or onboarding activities associated with onboarding plan.

As discussed, without an integrated onboarding platform, human resources management systems did not adequately support systematic management of onboarding across an organization. With the integrated onboarding platform various data sources and services in an organization can be integrated. For example, existing repositories and new repositories of relevant data (e.g., human resources databases, IT databases, and department databases) can be identified and defined and made accessible via the integrated onboarding platform. Specific types of data can be aggregated from the different sources (e.g., via APIs— Application Programming Interfaces). The aggregated data (e.g., onboarding management data) can be selected to align with the needs of the different onboarding experiences and onboarding data provided using the different onboarding experiences. For example, the integrated onboarding platform may define a set of onboarding management data that are retrieved from the plurality of data sources and services and stored in the integrated onboarding platform.

Moreover, the integrated onboarding platform can be associated with different types of services and systems. For example, an organization may already implement a meeting management service (e.g., MICROSOFT TEAMS), an employee experience service (e.g., MICROSOFT VIVA), and a cloud computing service (e.g., MICROSOFT AZURE), and these services are integrated to the onboarding platform. The different services and systems can be strategically and selectively incorporated into different onboarding experiences. For example, the meeting management service (e.g., meeting management engine) can provide business communication platform features as an underlying framework for communication and providing interfaces for the integrated onboarding platform. For example, an onboarding activity—that includes a meeting—can be automatically instantiated via features of meeting management engine.

Onboarding experiences can be associated with data (e.g., onboarding configuration data) that is retrieved via an employee experience service that supports communications, knowledge, learning, resources, and insights in the flow of work. For example, a plan builder experience can be developed based on learning services, people services, and resources that are supported by the employee experience service. And, the distributed computing service can provide features that support distributed storage, credential management, and user and document intelligence and analytics that can be used in generating and presenting different onboarding experiences. For example, a dashboard experience and status information can be automatically generated through user and document intelligence and analytics—associated with cloud-based productivity tools—and provided on a dashboard.

In addition to relying on integrated services and systems, the integrated onboarding platform can support novel process integration. Organizational onboarding logistics can be programmatically defined to support identifying features and onboarding activities that correspond to onboarding processes. The organizational onboarding logistics can specifically implemented based on a hierarchical computing architecture, constructs, and rules (e.g., prioritize organizational level configuration over department or manager level configuration). Organizational onboarding logistics can be codified to set restrictions, recommendations, and systematically perform, manage, assign, and track onboarding features and onboarding activities for different types of users. For example, onboarding activities that are required may not be bypassed and may be required to be performed before a period of time has expired. Onboarding activities at an organizational level may not be moved by an onboarding manager user or an onboarding contributor user.

The organizational onboarding logistics can codified into plan builder templates that can be used as onboarding plan baselines for different types of onboarding users or departments. The organizational onboarding logistics can be codified based on integrating existing onboarding workflows to create an integrated onboarding workflow and removes duplication, support targeting of content, and provides transparency across departments.

Hierarchical integration can generally refer to hierarchical level onboarding configuration data that are programmed into or associated with an onboarding plan. In this context, the onboarding configuration data can include features, onboarding activities, timing, restrictions, people, and services that are accessible or restricted based on the particular type of user (e.g., onboarding administrator user versus onboarding contributor user) or based on the different organizational levels (e.g., organizational level versus department level). Onboarding plans can be defined (and co-authored) by several different hierarchical users that update the onboarding plan based on their association with onboarding activities and their corresponding attributes.

The integrated onboarding platform further provides automated functionality for the onboarding workflow. Automated functionality can be associated with different process steps of the onboarding workflow. For example, the integrated onboarding platform can include assignment logic for automatically assigning different types of onboarding activities to onboarding users based on onboarding user profile information (e.g., role, start date, department, etc.). Notifications, meetings, and updates associated with onboarding plans can be automatically implemented, generated, and communicated based on automation logic that is supported at the integrated onboarding platform. For example, an onboarding manager user can receive a notification reminding the onboarding manager user to build an onboarding plan for a new employee or update the onboarding manager user of a status of an onboarding user. The automated functionality can be associated with the different data sources and services to automatically support performing different types of onboarding management operations (e.g., identifying relevant resources associated with building a onboarding plan and performing an onboarding activity).

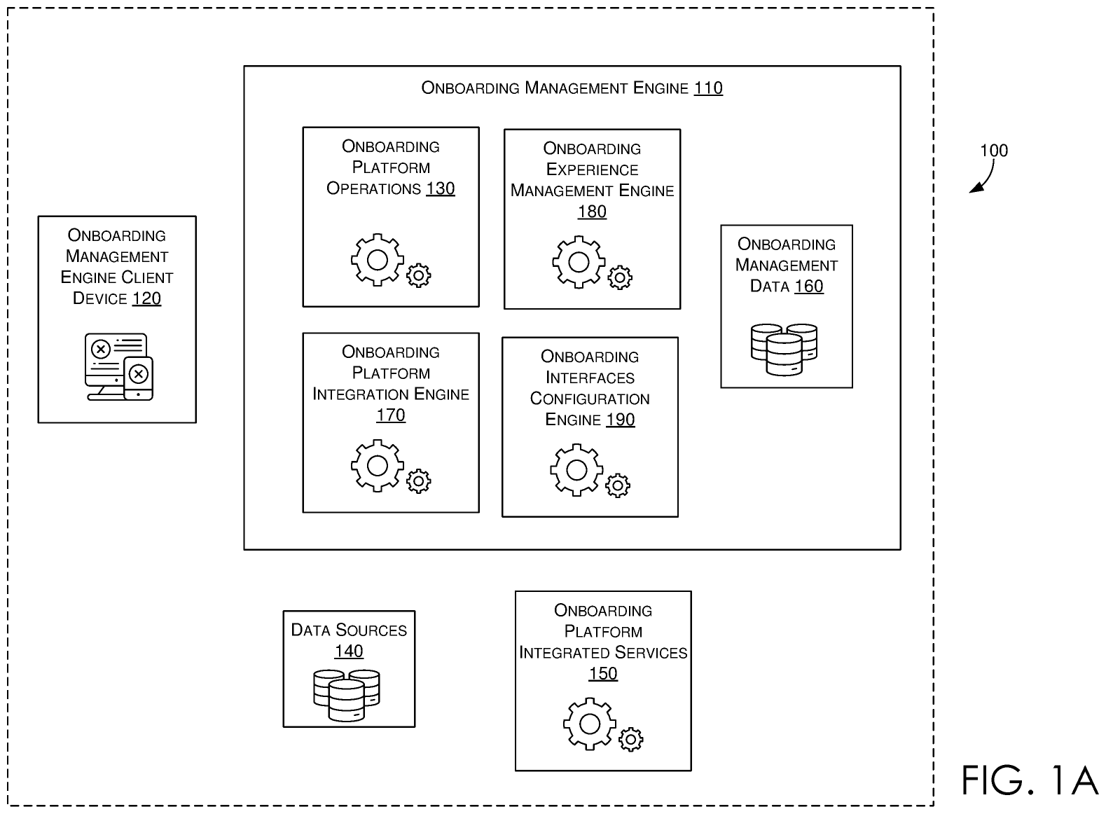

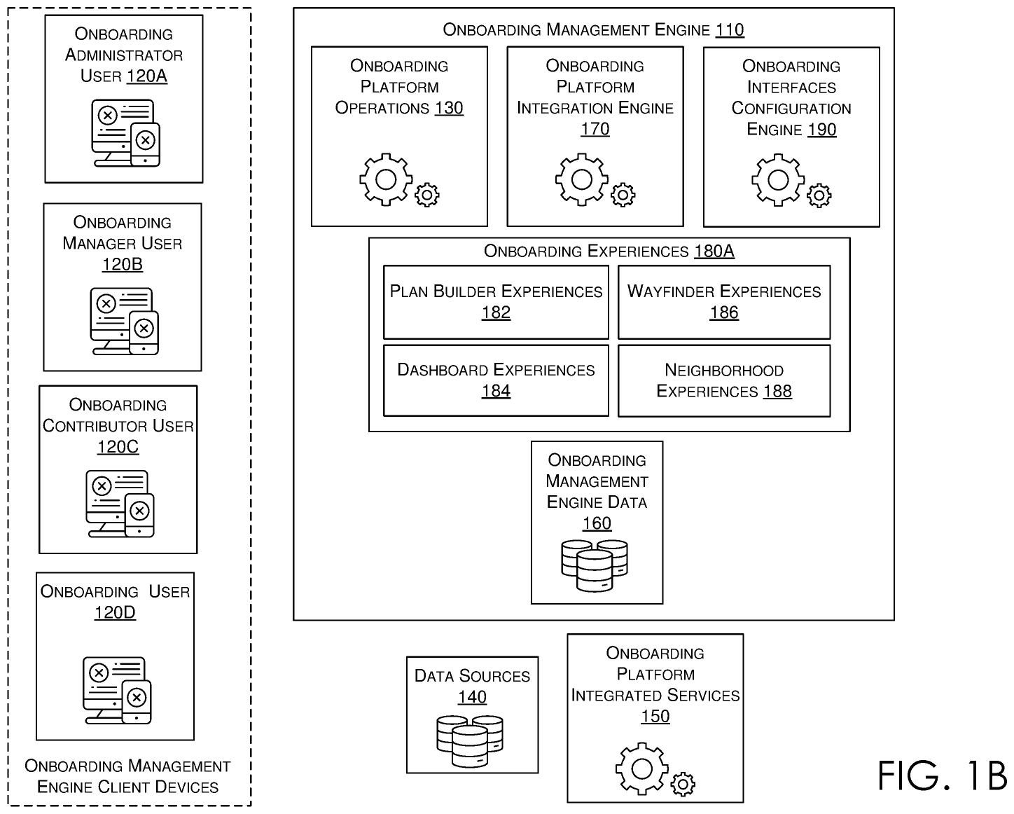

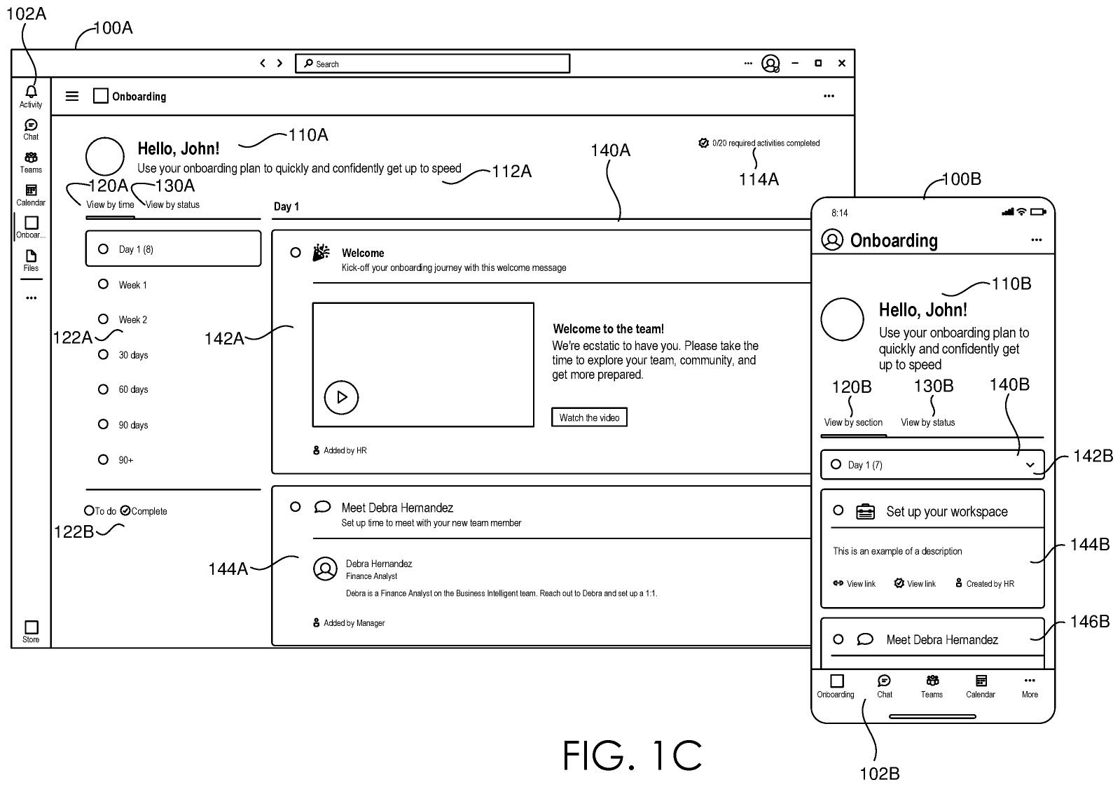

Aspects of the technical solution can be described by way of examples and with reference to FIGS. 1A, 1B, and 1C. FIG. 1A illustrates a human resources management system 100, onboarding management engine 110, onboarding management engine client device 120, onboarding platform operations 130, data sources 140, onboarding platform integrated services 150, onboarding management engine data 160, onboarding platform integration engine 170, onboarding experience management engine 180, and onboarding interfaces configuration engine 190.

At a high level, the human resources management system 100 provides a computing environment that hosts the onboarding management engine 110. The onboarding management engine supports providing an integrated onboarding platform. The integrated onboarding platform provides integrated onboarding management based on a computing architecture that supports system integration and process integration associated with an onboarding workflow. The onboarding management engine 110 operates (e.g., via onboarding platform operations 130) based on organizational onboarding logistics and hierarchical integration of onboarding activities of the onboarding workflow having corresponding onboarding interfaces.

The onboarding management engine 110 connects to a plurality of data (e.g., data sources 140) and services (e.g., onboarding platform integrated services) to identify onboarding management data 160 (also referred to as “onboarding data” provided via onboarding experiences). The onboarding management data 160 can refer to specific data that are retrieved and generated to support onboarding management. In particular, the onboarding management data can support onboarding configuration data having onboarding configuration data attributes (e.g., content, timing, assignment logic, users, status, and people) and onboarding data that is used to generate onboarding experiences.

The onboarding platform integrated services 150 and the onboarding platform integration engine 170 support integrating different services and systems strategically and selectively into different onboarding experiences. The onboarding platform integrated services 150 include the different types of services that are integrated into the onboarding management engine 110 and the onboarding platform integration engine 170.

The onboarding management data 160 is provided to different types of users (e.g., administrator user, manager user, contributor user, and onboarding user) via client devices (e.g., onboarding management engine client device 120) that supports accessing relevant onboarding management data 160 in each context and in association with each on boarding experience (e.g., plan builder experience, wayfinder experience, dashboard experience, and neighborhood experience). The onboarding management engine 110 further supports onboarding platform integration engine 170, onboarding experience management engine 180, onboarding interfaces configuration engine 190 to provide integration, experiences, and interfaces, associated with the functionality described herein.

With reference to FIG. 1B, FIG. 1B illustrates additional aspects of the human resources management system 100 and onboarding management engine 110. FIG. 1B includes a plurality of onboarding management client devices including onboarding administrator user 120A, onboarding manager user 120B, onboarding contributor user 120C, and onboarding user 120D; and the onboarding management engine includes onboarding experiences 180A with plan builder experiences 182, dashboard experiences 184, wayfinder experiences 186, and neighborhood experiences.

The onboarding management client devices provide access to different types of users different onboarding experiences that area accessible by the different types of users. For example, the onboarding administrator user, onboarding manager user, and the onboarding contributor user can each have some capacity to edit onboarding configuration data associated with generating and updating an onboarding plan. The different users are associated with different experiences that are generated based on the onboarding configuration data. For example, a wayfinder experience can be accessible by an onboarding user—via onboarding user 120D— based on the onboarding configuration data causing assignment of the onboarding plan to the onboarding user.

With reference to FIG. 1C, FIG. 1C illustrates aspects of the human resources management system 100 associated with providing an integrated onboarding platform. FIG. 1C illustrates onboarding management interface 100A and onboarding management interface—mobile 100B that each support providing a particular manner for summarizing and presenting onboarding data. The onboarding management interface 100A can be based on or integrated with a communications management engine (e.g., business communication platform) that supports different types of functionality (e.g., chat, video-telephony) of an organization. The onboarding management interface 100A includes communications management interface icons 102A and the onboarding management interface 100B includes communications management interface icons—mobile 102B. The onboarding management interface 100A includes header interface portion 110A, view by time interface portion 120A, view by status interface portion 130A, details interface portion 140A, details panel 142A, and details panel 144A. The onboarding management interface 100B includes header interface portion 110B, details interface portion 140B, details panel 142B, details panel 144B, and details panel 146B. The different interface portions are associated with onboarding data and are generated for presentation based on onboarding configuration data associated with an onboarding user. As discussed in more detail below, several different experiences (e.g., Wayfinder, My Wayfinder, Neighborhood and My Neighborhood) as specific features with corresponding experiences interfaces provided via the integrated onboarding platform.

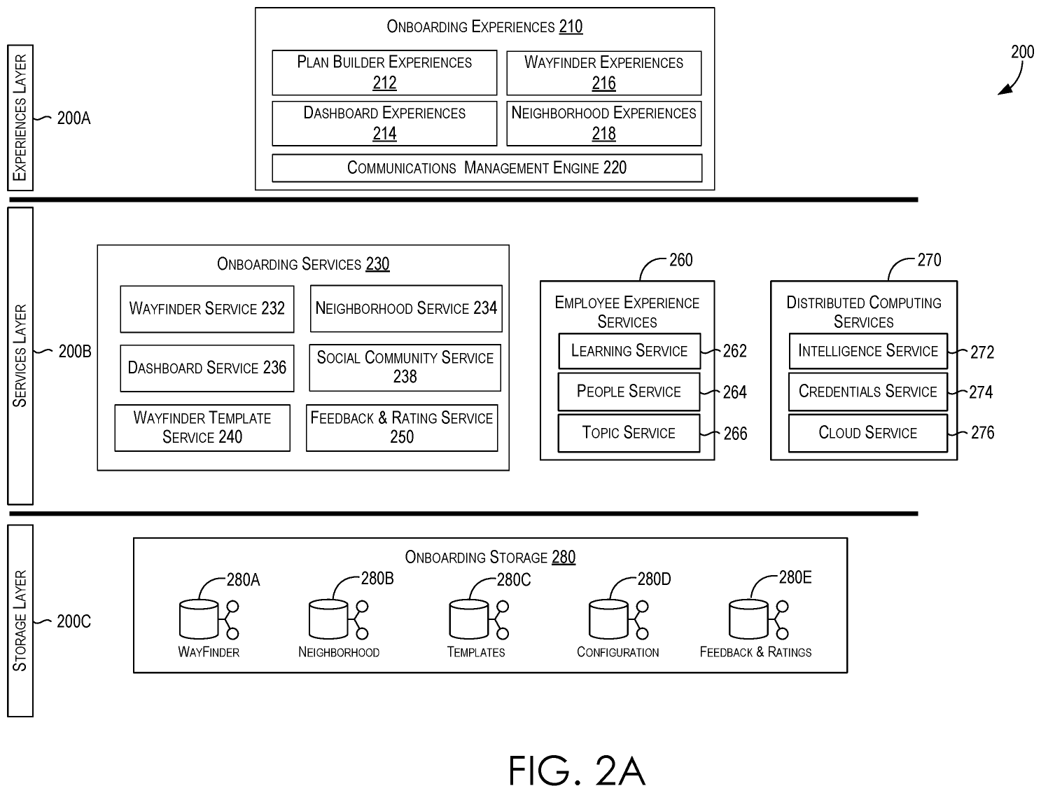

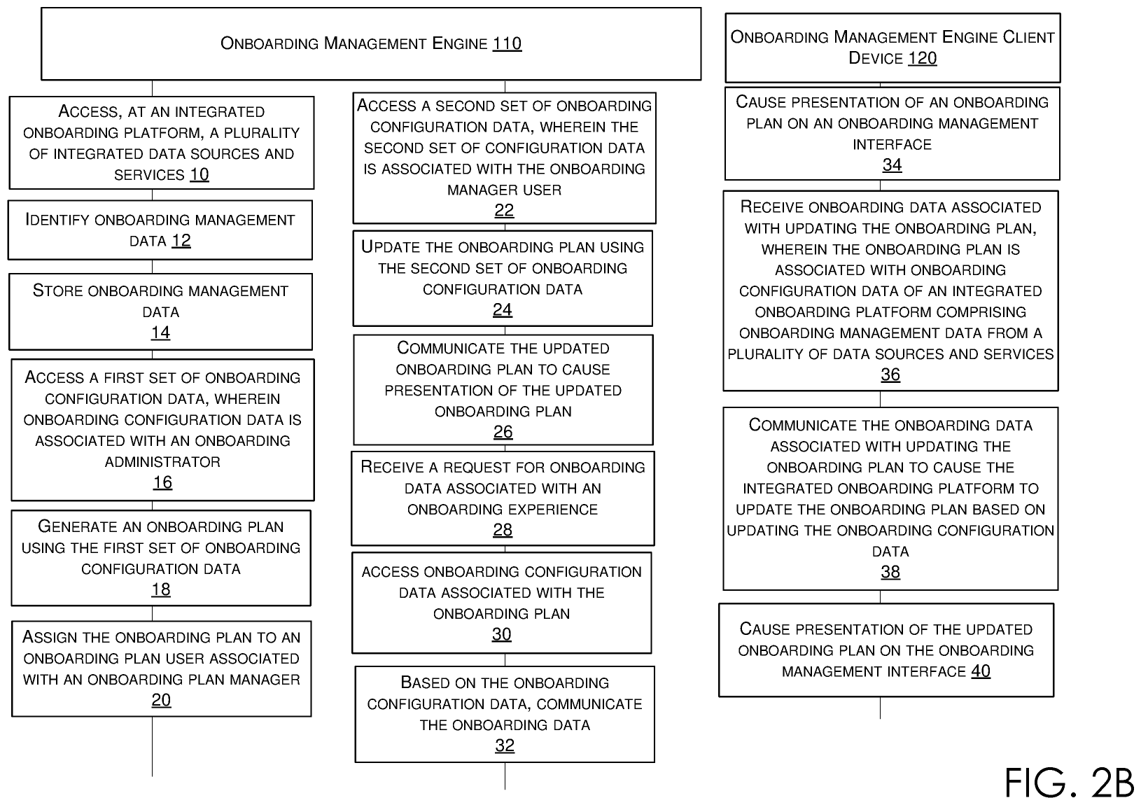

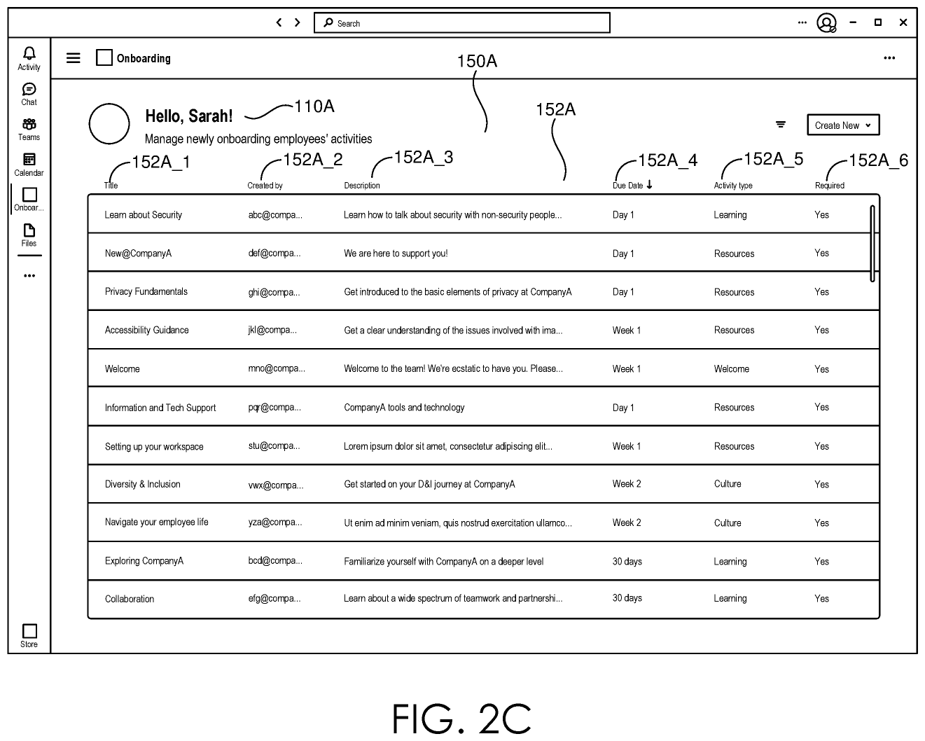

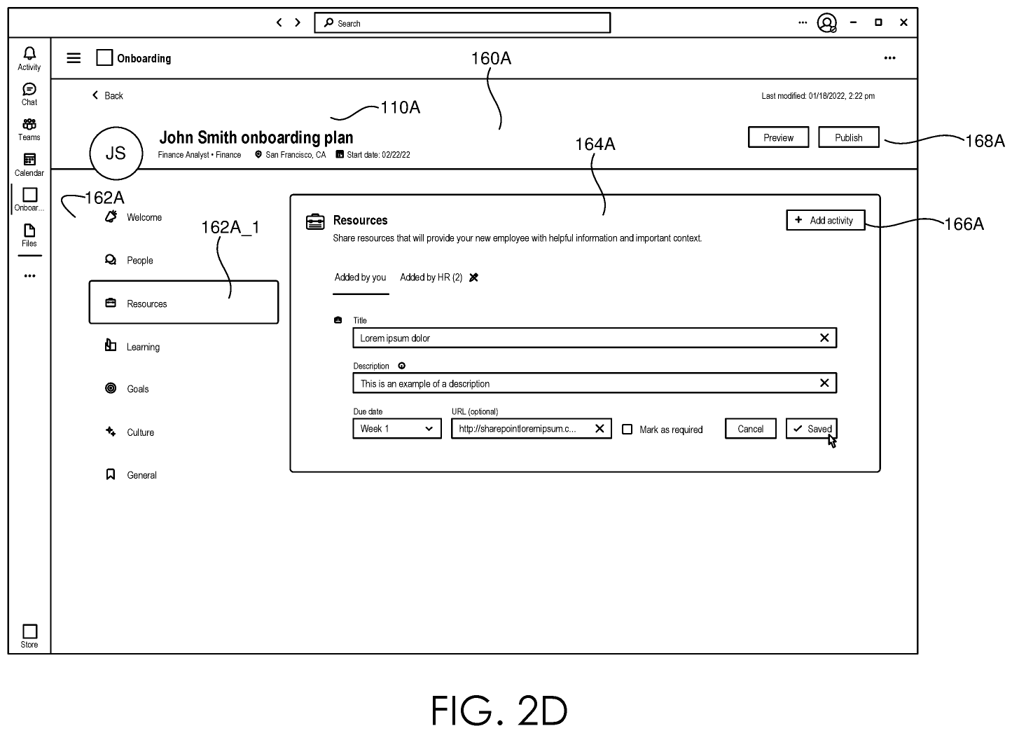

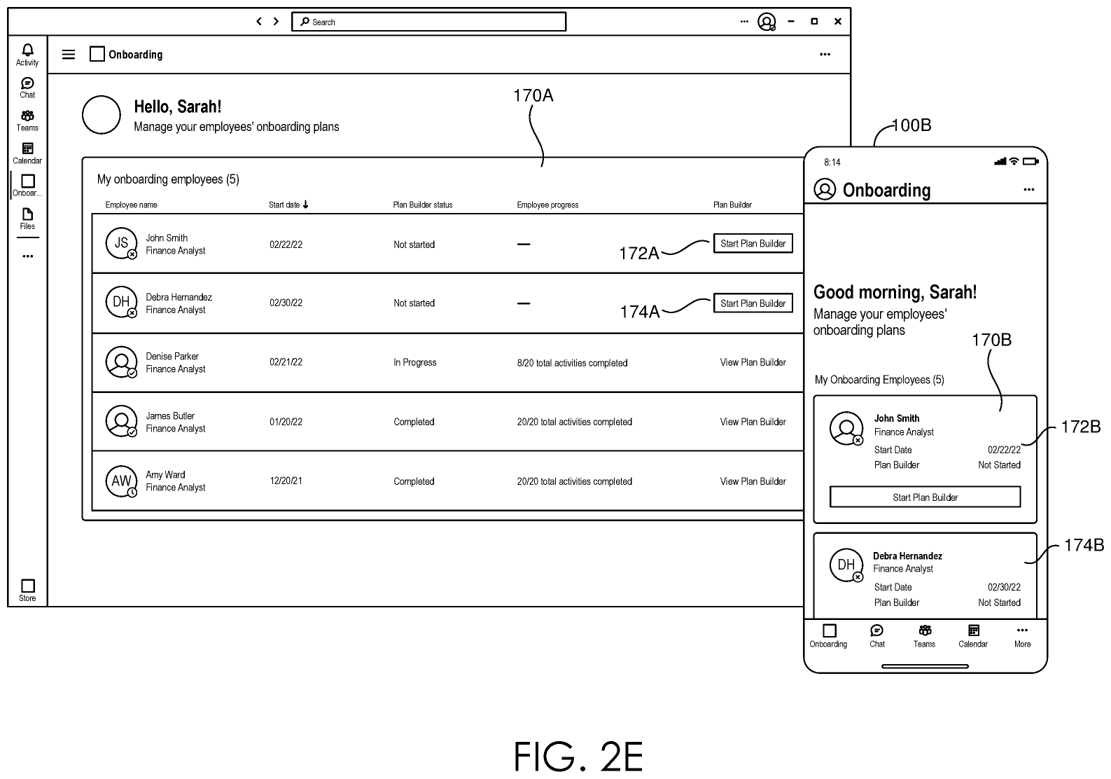

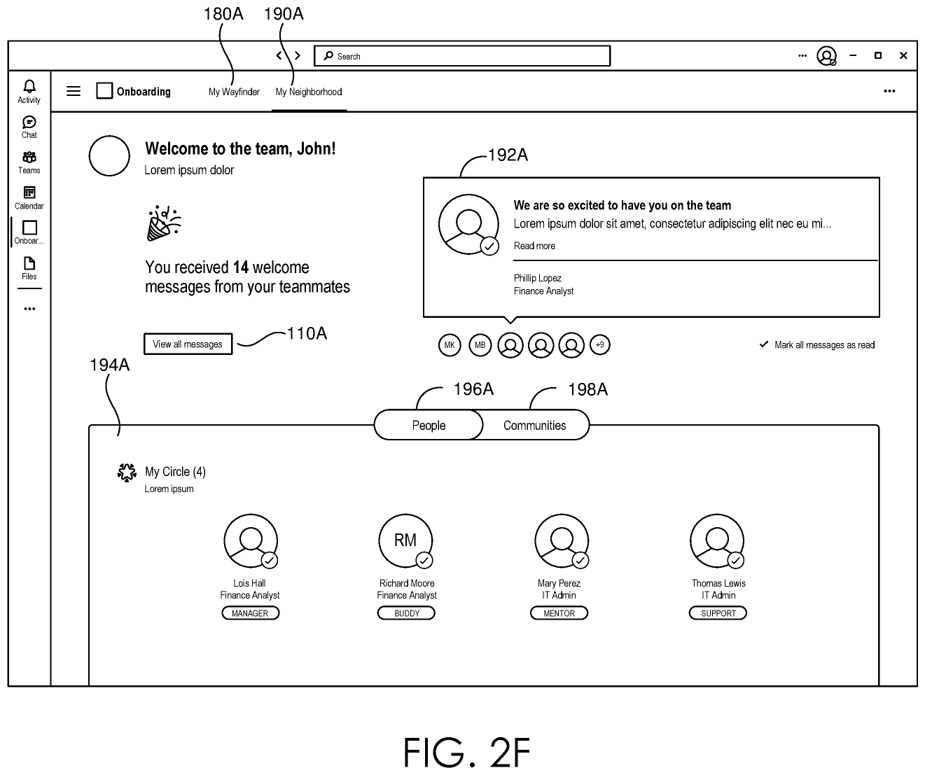

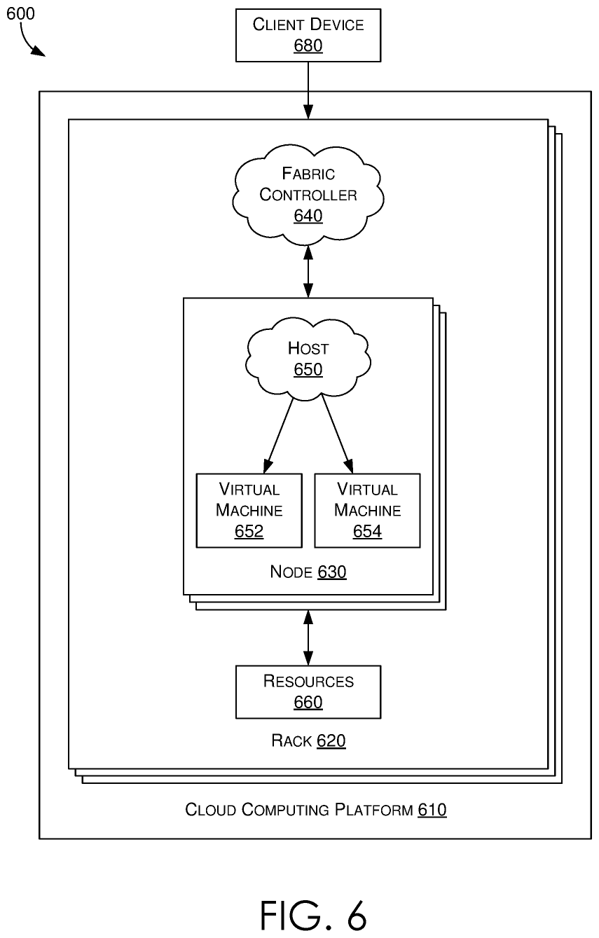

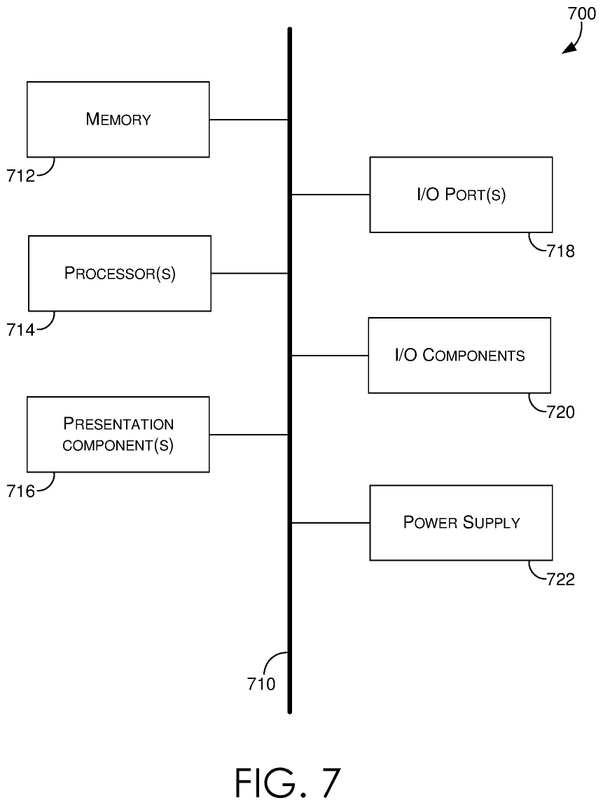

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example human resources management system 100 in which methods of the present disclosure may be employed. In particular, FIG. 2A shows a high level architecture of the human resources management system 100 in accordance with implementations of the present disclosure. Among other engines, managers, generators, selectors, or components not shown (collectively referred to herein as “components”), the technical solution environment of human resources management system 100 corresponds to FIGS. 1A and 1B.

With reference to FIG. 2A, FIG. 2A illustrates a schematic representation of an integrated onboarding management system architecture 200. The onboarding management system architecture can be based on layers that support different aspects of the onboarding management system. In the particular, the layers support integration framework for providing the functionality discussed herein. The layers include an experience layer 200A, a service layer 200B, and a storage layer 200C. The experience layer 100A includes onboarding experiences 210 with plan builder experiences 212, dashboard experiences 214, wayfinder experiences 216, neighborhood experiences, and communications management engine 220.

The onboarding management system architecture 200 includes the service layer 200B with onboarding services 230, employee experience services 260, and distributed computing services 270. The onboarding services 230 include wayfinder service 232, neighborhood service 234, dashboard service 236, community service 238, wayfinder template service 240, and feedback and rating service 250. The employee experience services 260 include learning service 262, people service 264, and topic service 266. The distributed computing services 270 includes intelligence service 272, credentials service 274, and cloud service 276. The storage layer includes onboarding storage 280 including wayfinder 280A, neighborhood 280B, templates 280C, configuration 280D, and feedback and rating 280E. The different layers are representative of computing abstractions of the onboarding management system architecture 200 that are associated with corresponding features and functionality (i.e., computing experiences, computing services, and computing storage).

In operation, the human resources system 100 supports receiving, at an onboarding management engine, a request for onboarding data associated with an onboarding experience. The request is received from one of the following users: an onboarding administrator user, an onboarding manager user, and an onboarding contributing user. The onboarding management engine 110 supports generating onboarding plans, the onboarding plans are associated with onboarding configuration data of an integrated onboarding platform including onboarding management data from a plurality of data sources and services. The integrated onboarding platform is integrated with each of the following services: a meeting management service, an employee experience service, and a cloud computing service.

The onboarding management engine 110 further supports assigning the onboarding plan to an onboarding user associated with an onboarding manager user. Assigning the onboarding plan is based on an assignment logic associated with the onboarding configuration data, where the assignment logic is based on user profile information associated with the onboarding user or an organizational onboarding logistics (e.g., onboarding logic).

The onboarding management data 160 is provided for selecting the onboarding configuration data for generating and updating the onboarding plan. The onboarding configuration data defines features and onboarding activities of the onboarding plan. A first set of features and onboarding activities are associated with a first hierarchal level of an organization and a second set of features and onboarding activities are associated with a second hierarchal level of the organization. The onboarding configuration data further comprises one or more features or onboarding activities that are excluded from alteration by a lower hierarchal level of an organization after configuration by a higher hierarchical level of the organization.

Based on the request, the onboarding management engine 110 accesses onboarding configuration data associated with the onboarding plan; and based on the onboarding configuration data, communicates the onboarding data. The onboarding management engine further supports communicating onboarding plans or updated onboarding plans to cause at least a portion of the onboard plan to be presented on an onboard management interface. The onboarding management interface supports interfaces associated with each of the following experiences: a plan builder experience, a wayfinder experience, a neighborhood experience, and dashboard experience.

With reference to FIG. 2B, FIG. 2B illustrates onboarding management engine 110 and onboarding management engine client device 120 that support providing corresponding operations for onboarding management. At block 10, access a plurality of integrated data sources and services. At block 12, identify onboarding management data. At block 14, store onboarding management data. At block 16, access a first set of onboarding configuration data. The first set of onboarding configuration data is associated with an onboarding administrator. At block 18, generate an onboarding plan using the first set of onboarding configuration data. At block 20, assign the onboarding plan to an onboarding user associated with an onboarding manager user. At block 22, access a second set of onboarding configuration data. The second set of onboarding configuration data is associated with the onboarding manager user. At block 24, update the onboarding plan using the second set of onboarding configuration data. At block 26, communicate the updated onboarding plan.

At block 28, receive a request for onboarding data associated with an onboarding experience. At block 30, based on the request, access onboarding configuration data associated with the onboarding plan. At block 32, based on the onboarding configuration data, communicate the onboarding data. At block 34, cause presentation of an onboarding plan on an onboarding management interface. At block 36, receive onboarding data associated with updating the onboarding plan. The onboarding plan is associated with onboarding configuration data of an integrated onboarding platform comprising onboarding management data from a plurality of data sources and services At block 38, communicate the onboarding data associated with updating the onboarding plan to cause the integrated onboarding platform to update the onboarding plan based on updating the onboarding configuration data. At block 40, cause presentation of the updated onboarding plan on the onboarding management interface.

With reference to FIGS. 2C-2F, FIGS. 2C-2F illustrate aspects—interface representations—associated with the onboarding management engine 110 and onboarding management engine 124. At a high level, onboarding management engine 124 operates to generate interface data (e.g., onboarding data and onboarding data interface elements). Interface data includes user interface elements, onboarding data visualizations, and instructions on how to generate corresponding user interfaces that support interactions between users and the human resources management system.

User interfaces allow effective operation and control by users while the human resources management system simultaneously perform computing operations. Interface data can include graphical user interfaces that allow users to interact with the human resources management system 100. A graphical user interface can include data visualization that that provides a visual display of onboarding data. The onboarding data can specifically include onboarding data interface elements associated onboarding data.

Turning to FIG. 2C, FIG. 2C illustrates plan builder interface 150A and a header interface portion 110A. The plan builder interface includes plan builder categories 152A, title 152A_1, created by 152A_2, description 152A_3, due date 152A_4, activity type 152A_5, and required 152A_6. FIG. 2D illustrates plan builder interface 150A and a header interface portion 110A. The plan builder configuration interface includes plan builder configuration categories 162A, resources 162A_1, plan builder configuration details panel 164A, add activity 166A, and preview-publish buttons 168A.

FIG. 2E illustrates plan builder interface 150A and a header interface portion 110A. Plan builder operations interface 170A includes plan builder operation (“Start Plan Builder”) 172A, plan builder operation (Start Plan Builder”) 174A, plan builder operations interface—mobile 170B, plan builder operation—mobile 172B and plan builder operation mobile 174B.

FIG. 2F illustrates selectable tabs—my wayfinder interface 180A and my neighborhood interface 190A and header interface portion 110A. With my neighborhood interface 190A selected the interface includes my neighborhood information panel 192A, my neighborhood details panel 194A, details panel tab 196A and details panel tab 198A.

### Exemplary Methods

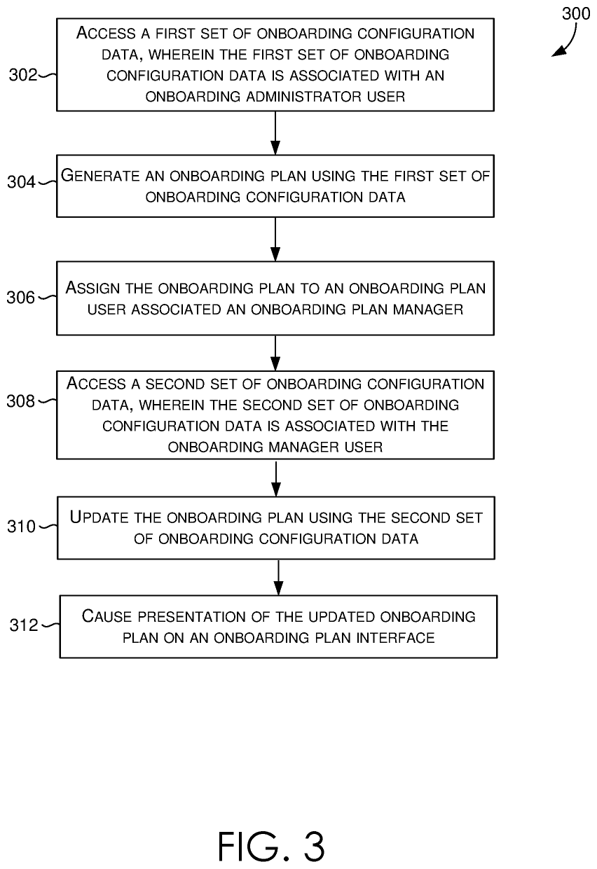

With reference to FIGS. 3, 4, and 5, flow diagrams are provided illustrating methods for providing an integrated onboarding platform associated with an onboarding management engine of a human resources management system. In embodiments, one or more computer-storage media having computer-executable or computer-useable instructions embodied thereon that, when executed, by one or more processors can cause the one or more processors to perform the methods (e.g., computer-implemented method) in the human resources management system (e.g., a computerized system or computing system).

Turning to FIG. 3, a flow diagram is provided that illustrates a method 300 for providing an integrated onboarding platform associated with an onboarding management engine of a human resources management system. At block 302, access, at an onboarding management engine, a first set of onboarding configuration data, wherein onboarding configuration data is associated with an onboarding administrator user. At block 304, generate an onboarding plan using the first set of onboarding configuration data. At block 306, assign the onboarding plan to an onboarding user associated with an onboarding plan manager. At block 308, access a second set of onboarding configuration data, wherein the second set of onboarding configuration data is associated with the onboarding manager user. At block 310, update the onboarding plan using the second set of onboarding configuration data. At block 312, cause presentation of the updated onboarding plan on an onboarding management interface.

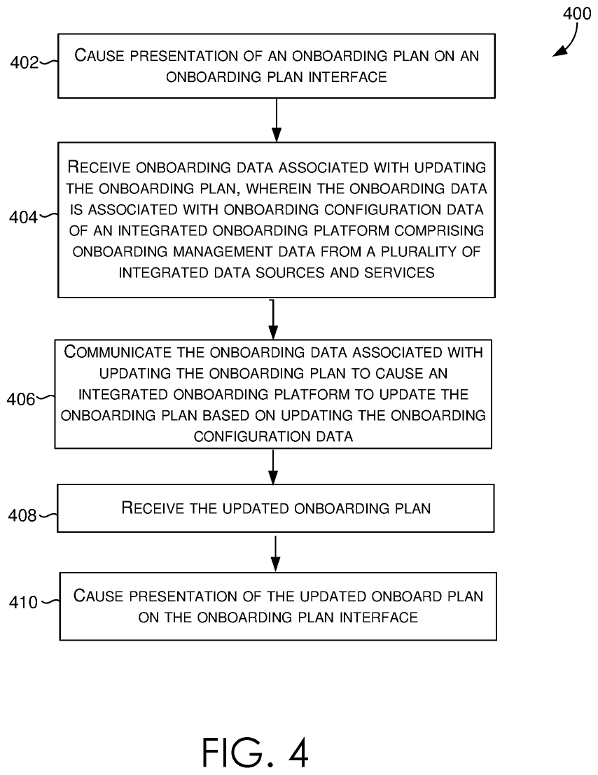

Turning to FIG. 4, a flow diagram is provided that illustrates a method 400 for providing an integrated onboarding platform associated with an onboarding management engine of a human resources management system. At block 402, cause presentation of an onboarding plan on an onboarding management interface. At block 404, receive onboarding data associated with updating the onboarding plan. The onboarding data is associated with onboarding configuration data of an integrated onboarding platform comprising onboarding management data from a plurality of integrated data sources and services. At block 406, communicate the onboarding data associated with updating the onboarding plan to cause the integrated onboarding platform to update the onboarding plan based on updating the onboarding configuration data. At block 408, received the updated onboarding plan. At block 408, cause presentation of the updated onboarding plan on the onboarding management interface.

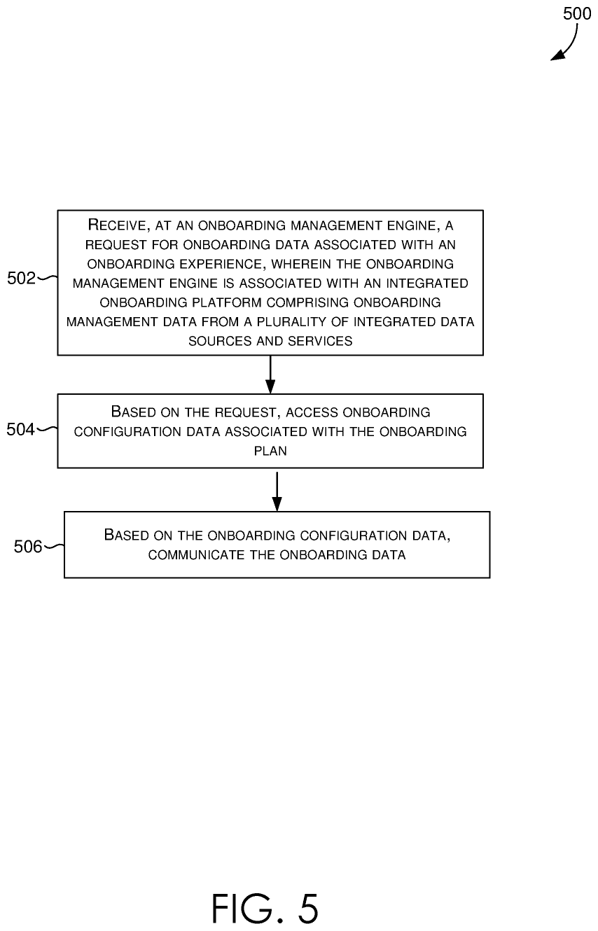

Turning to FIG. 5, a flow diagram is provided that illustrates a method 500 for providing an integrated onboarding platform associated with an onboarding management engine of a human resources management system. At block 502, receive, at an onboarding management engine, a request for onboarding data associated with an onboarding experience. The onboarding management engine is associated with an integrated onboarding platform comprising onboarding management data from a plurality of integrated data sources and services. At block 504, based on the request, access onboarding configuration data associated with the onboarding plan. At block 506, based on the onboarding configuration data, communicate the onboarding data.

Embodiments of the present invention have been described with reference to several inventive features (e.g., operations, systems, engines, and components) associated with a human resources management system having a meeting management engine and onboarding management engine for providing an integrated onboarding platform associated with an onboarding management engine of a human resources management system. Inventive features described include: operations, interfaces, data structures, and arrangements of computing resources associated with providing the functionality described herein relative with reference to meeting management engine and onboarding management engine and user interfaces providing user interaction models. Functionality of the embodiments of the present invention have further been described, by way of an implementation and anecdotal examples to demonstrate that the operations for providing the integrated onboarding platform are an unconventional ordered combination of operations that operate with an onboarding management engine as a solution to a specific problem in meeting management technology environment to improve computing operations and interfaces for user interface navigation in human resources management systems. Overall, these improvements result in less CPU computation, smaller memory requirements, and increased flexibility in human resources management systems when compared to previous conventional human resources management system operations performed for similar functionality.

### ADDITIONAL SUPPORT FOR DETAILED DESCRIPTION OF THE INVENTION

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present invention, an example operating environment in which embodiments of the present invention may be implemented is described below in order to provide a general context for various aspects of the present invention. Referring initially to FIG. 6 in particular, an example operating environment for implementing embodiments of the present invention is shown and designated generally as computing device 600. Computing device 600 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system, the computerized system comprising:
at least one computer processor; and
computer memory storing computer-useable instructions that, when used by the at least one computer processor, cause the at least one computer processor to perform operations comprising:
an onboarding platform integration engine configured for integrating a plurality of data sources and services into an integrated onboarding platform comprising onboarding management data;
an onboarding experience management engine configured for generating one or more of the following experiences: a plan builder experience, a wayfinder experience, a neighborhood experience, and a dashboard experience;
an onboarding interfaces configuration engine configured for generating interfaces associated with one or more of the following: the plan builder experience, the wayfinder experience, the neighborhood experience, and the dashboard experience;
an onboarding management engine configured for:
accessing a first set of onboarding configuration data, wherein the first set of onboarding configuration data is associated with an onboarding administrator user, wherein the onboarding management engine supports generating onboarding plans, the onboarding plans are associated with onboarding configuration data of the integrated onboarding platform;
generating an onboarding plan using the first set of onboarding configuration data;
assigning the onboarding plan to an onboarding user associated with an onboarding manager user;
accessing a second set of onboarding configuration data, wherein the second set of configuration data is associated with the onboarding manager user;
updating the onboarding plan using the second set of onboarding configuration data; and
based on the onboarding data, updating the onboarding plan; and
communicating the updated onboarding plan.

2. The computerized system of claim 1, wherein onboarding management data is provided from the plurality of data sources and services for selecting onboarding configuration data for generating and updating the onboarding plan.

3. The computerized system of claim 1, wherein the onboarding configuration data defines features and onboarding activities of the onboarding plan, wherein a first set of features and onboarding activities are associated with a first hierarchal level of an organization and a second set of features and onboarding activities are associated with a second hierarchal level of the organization.

4. The computerized system of claim 1, wherein the onboarding configuration data comprises one or more features or onboarding activities that are excluded from alteration by a lower hierarchal level of an organization after configuration by a higher hierarchical level of the organization.

5. The computerized system of claim 1, wherein assigning the onboarding plan is based on an assignment logic associated with the onboarding configuration data, wherein the assignment logic is based on user profile information associated with the onboarding user or an organizational logistics logic.

6. The computerized system of claim 1, wherein the integrated onboarding platform is integrated with each of the following services: a meeting management service, an employee experience service, and a cloud computing service.

7. The computerized system of claim 1, wherein communicating the updating onboarding plan causes at least a portion of the onboard plan to be presented on an onboard management interface, wherein the onboarding management interface supports interfaces associated with each of the following experiences: the plan builder experience, the wayfinder experience, the neighborhood experience, and the dashboard experience.

8. One or more computer-storage media having computer-executable instructions embodied thereon that, when executed by a computing system having a processor and memory, cause the processor to perform operations comprising:
causing presentation, on an onboarding management interface, of an onboarding plan, wherein the onboarding management interface supports interfaces associated with one or more of the following experiences: a plan builder experience, a wayfinder experience, a neighborhood experience, and a dashboard experience;
receiving onboarding data associated with updating the onboarding plan, wherein the onboarding plan is associated with onboarding configuration data of an integrated onboarding platform comprising onboarding management data from a plurality of data sources and services;
communicating the onboarding data associated with updating the onboarding plan to cause the integrated onboarding platform to update the onboarding plan based on updating the onboarding configuration data;
receiving the updated onboarding plan associated with the updated onboarding configuration data; and
causing presentation of the updated onboarding plan on the onboarding management interface in association with one or more of the following experiences: the plan builder experience, the wayfinder experience, the neighborhood experience, and the dashboard experience.

9. The one computer-storage media of claim 8, wherein the onboarding management data is provided from the plurality of data sources and services for selecting onboarding configuration data for generating and updating the onboarding plan.

10. The one computer-storage media of claim 8, wherein the onboarding configuration data defines features and onboarding activities of the onboarding plan, wherein a first set of features and onboarding activities are associated with a first hierarchal level of an organization and a second set of features and onboarding activities are associated with a second hierarchal level of the organization.

11. The one computer-storage media of claim 8, wherein the onboarding configuration data comprises one or more features or onboarding activities that are excluded from alteration by a lower hierarchal level of an organization after configuration by a higher hierarchical level of the organization.

12. The one computer-storage media of claim 8, wherein the integrated onboarding platform is integrated with each of the following services: a meeting management service, an employee experience service, and a cloud computing service.

13. The one computer-storage media of claim 8, wherein the onboarding plan is associated with a first set of onboarding configuration data corresponding to an onboarding administrator user; a second set of onboarding configuration data associated with an onboarding manager user; and a third set of onboarding configuration data associated with an onboarding contributor user.

14. The one computer-storage media of claim 8, wherein the onboarding data is received from one of the following users: an onboarding administrator user, an onboarding manager user, and an onboarding contributing user.

15. A computer-implemented method, the method comprising:
receiving, at an onboarding management engine, a request for onboarding data associated with an onboarding experience, wherein the onboarding management engine supports generating onboarding plans, the onboarding plans are associated with onboarding configuration data of an integrated onboarding platform comprising onboarding management data from a plurality of data sources and services;
based on the request, accessing onboarding configuration data associated with the onboarding plan, wherein the onboarding configuration data is associated with one or more of the following: the plan builder experience, the wayfinder experience, the neighborhood experience, and the dashboard experience; and
based on the onboarding configuration data, communicating the onboarding data.

16. The computer-implemented method of claim 15, wherein onboarding management data is provided from the plurality of data sources and services for selecting onboarding configuration data for generating and updating the onboarding plan data.

17. The computer-implemented method of claim 15, wherein the onboarding configuration data defines features and onboarding activities of the onboarding plan, wherein a first set of features and onboarding activities are associated with a first hierarchal level of an organization and a second set of features and onboarding activities are associated with a second hierarchal level of the organization.

18. The computer-implemented method of claim 15, wherein the integrated onboarding platform is integrated with each of the following services: a meeting management service, an employee experience service, and a cloud computing service.

19. The computer-implemented method of claim 15, wherein the request is received from one of the following users: an onboarding administrator user, an onboarding manager user, and an onboarding contributing user.

20. The computer-implemented method of claim 15, wherein the onboarding experience corresponds to any of the following: a plan builder experience, a wayfinder experience, a neighborhood experience, and a dashboard experience.
